(19) United States
(12) Patent Application Publication
(10) Pub. No.: US 2008/0289718 A1
(43) Pub. Date: Nov. 27, 2008

(54) Liquid vacuum apparatus and method

(76) Inventor: Gary Drew, Maquoketa, IA (US)

Correspondence Address: HAMILTON IP LAW, PC, 331 W. 3RD ST., NEW VENTURES CENTER SUITE 120, DAVENPORT, IA, 52801, US

(21) Appl. No.: 12/070,762

(22) Filed: Feb. 21, 2008

Related U.S. Application Data
(60) Provisional application No. 60/931,641, filed on May 24, 2007.

(51) Int. Cl. B08B 9/08; A47L 5/36; F04F 3/00

(52) U.S. Cl. 141/1; 15/327.1; 141/65; 134/21

(57) ABSTRACT

The various embodiments disclosed and pictured herein illustrate a liquid vacuum apparatus and method that is easy to operate, provides increased safety for operators, mitigates the risk of operator exposure to the liquid, and mitigates the risk of liquid spillage during and after the liquid is transported. As described herein, the liquid vacuum apparatus may be employed either with or without the connector, piping, and end piece; and if an end piece is used, it may take many different forms depending on the particular application.

### CROSS REFERENCE TO RELATED APPLICATIONS

Applicant, Gary Drew, a United States Citizen residing in Maquoketa, Iowa, claims priority under 35 U.S.C. §119(e) of provisional U.S. Patent Application Ser. No. 60,931,641 filed on May 24, 2007 which is incorporated by reference herein.

### FIELD OF INVENTION

The present invention relates to an apparatus and method for removing liquid from a liquid container.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### SUMMARY OF THE INVENTION

The present invention provides for an efficient, sanitary, and safe means of removing liquids from a liquid container. More specifically, exemplary embodiments of the present invention provide an apparatus for evacuating used oil from an oil-type food fryer while minimizing the operator exposure to the oil and the likelihood of spillage during transfer of the oil.

The liquid vacuum apparatus employs a vacuum pump 2 in fluid communication with a storage tank 1. The vacuum pump 2 operates to create an atmosphere within the storage tank 1 with a pressure below that of ambient pressure (that is, generally less than one atmosphere, depending on elevation above sea level). Fluidly connected to the storage tank 1 through a flexible hose 9 and associated piping 13 (in certain embodiments) is a wand 10 with an end piece 11. In one embodiment, the wand 10 is simply a contoured pipe that provides the user interface and the end piece 11 a screen that acts as a filter. The end piece 11 is not required in every embodiment described and disclosed herein.

During operation, the user first engages the vacuum pump 2 (which may be configured to exhaust either indoors or outdoors) to reduce the pressure within the storage tank 1. Next, the user places the end piece 11 or the open end of the wand 10 into the liquid that is to be evacuated from the liquid container. The reduced pressure within the storage tank 1 acts as a motive force to urge the liquid into the storage tank 1 due to the pressure gradient. In the embodiments pictured herein, the liquid is used oil 15 and the liquid container is a food fryer 14, but the scope of the present invention is not limited by the specific type of liquid or liquid container for which the apparatus is configured.

When the user has evacuated the desired amount of liquid from the liquid container, the user may then allow air to pass through the system for a certain amount of time to ensure that all liquid is removed from the wand 10, hose 9, and piping 13. The user is then able to disconnect the hose 9 from the piping 13 at the connector 12 without any spillage of liquid.

Because the liquid vacuum apparatus uses negative pressure as the motive force (through the use of the vacuum pump 2) rather than positive pressure (such as a centrifugal, positive displacement, or similar pump), the possibility of spilling liquid during evacuation of the liquid from a liquid container is greatly reduced. If a leak develops in the system, liquid will not be forced from the leaking area as it would in a positive pressure system; rather, the vacuum pump 2 will pull air through the leaking area, and the liquid will not leak externally. This makes the liquid vacuum apparatus much safer to use, and it facilitates evacuation of used oil 15 at nearly any temperature, depending on the material characteristics of the hose 9, wand 10, piping 13, connector 12, end piece 11, vacuum pump 2, and storage tank 1.

Though the embodiments shown in the figures included herein are directed towards applications involving evacuating used oil 15 from food fryers 14, other embodiments are described and disclosed in the specification, and the specific application to used oil 15 from food fryers 14 does not limit the scope of the present invention.

### BRIEF DESCRIPTION OF THE FIGURES

FIG. 1 provides a schematic view of the storage tank and vacuum pump portions of the system.

FIG. 2 provides a schematic view of the storage tank and vacuum pump with the wand and hose connected to the storage tank.

FIG. 3 provides a side view of the wand submerged in a liquid container from which the liquid is being evacuated.

FIG. 4 provides a schematic view of the storage tank during transfer of the contents in the storage tank to a transport vehicle.

FIG. 5 provides a schematic view of one embodiment of the liquid vacuum apparatus.

FIG. 6 shows an operator using the liquid vacuum apparatus to evacuate used oil from a food fryer.

FIG. 7 provides another view of an operator using the liquid vacuum apparatus to evacuate used oil from a food fryer.

FIG. 8 provides a side view of the storage tank.

FIG. 9 provides another side view of the storage tank and the associated piping.

FIG. 10 shows the storage tank not fluidly connected to any piping.

FIG. 11 provides a side view of the wand and end piece.

### DETAILED DESCRIPTION—LISTING OF ELEMENTS

| ELEMENT DESCRIPTION | ELEMENT # |
|---|---|
| Storage Tank | 1 |
| Vacuum Pump | 2 |
| Dip Tube | 3 |
| Vent | 4 |
| Load Out Nozzle | 5 |
| Tank Inlet | 6 |
| Pump Inlet | 7 |
| Pump Outlet | 8 |
| Hose | 9 |
| Wand | 10 |
| End Piece | 11 |
| Connector | 12 |
| Piping | 13 |
| Food Fryer | 14 |
| Used Oil | 15 |
| Wand First End | 16 |
| Wand Second End | 17 |
| Vent Hood | 18 |

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

### DETAILED DESCRIPTION

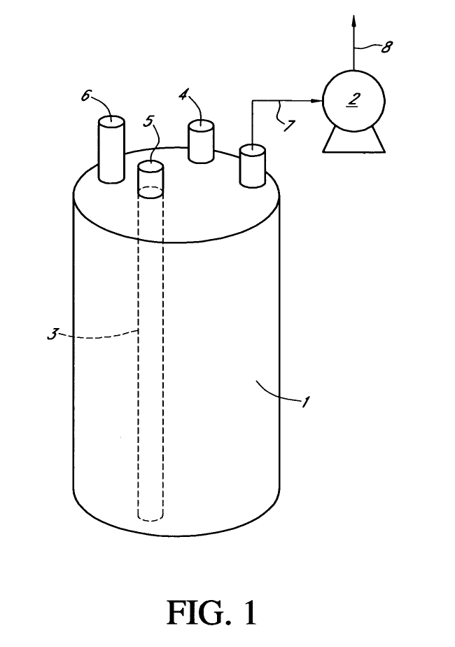

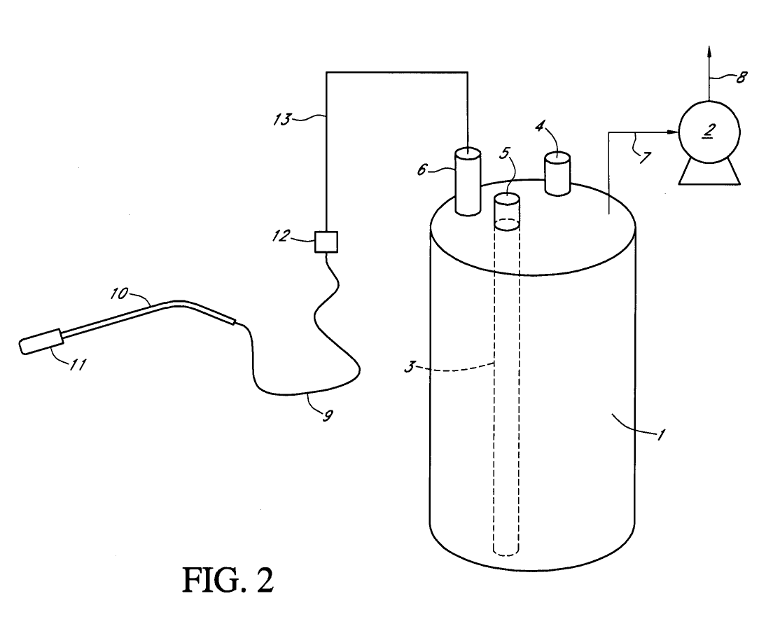

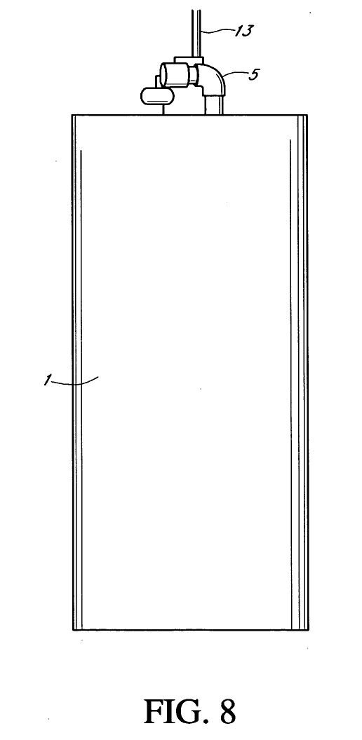

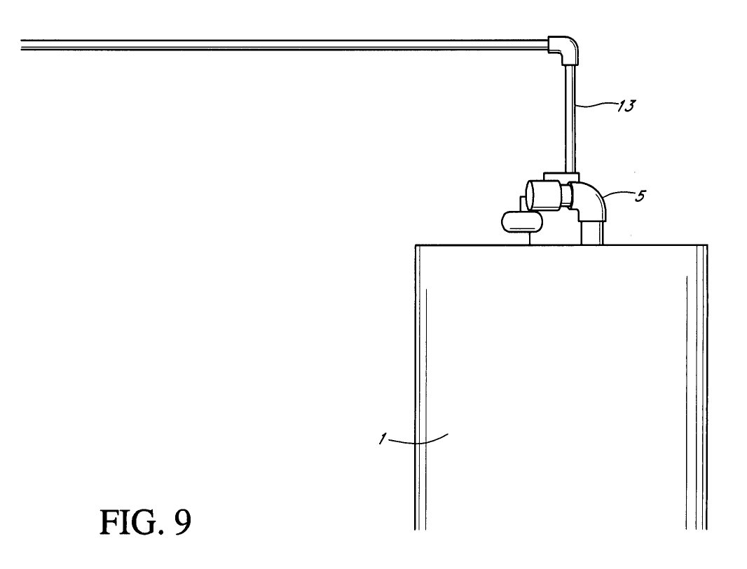

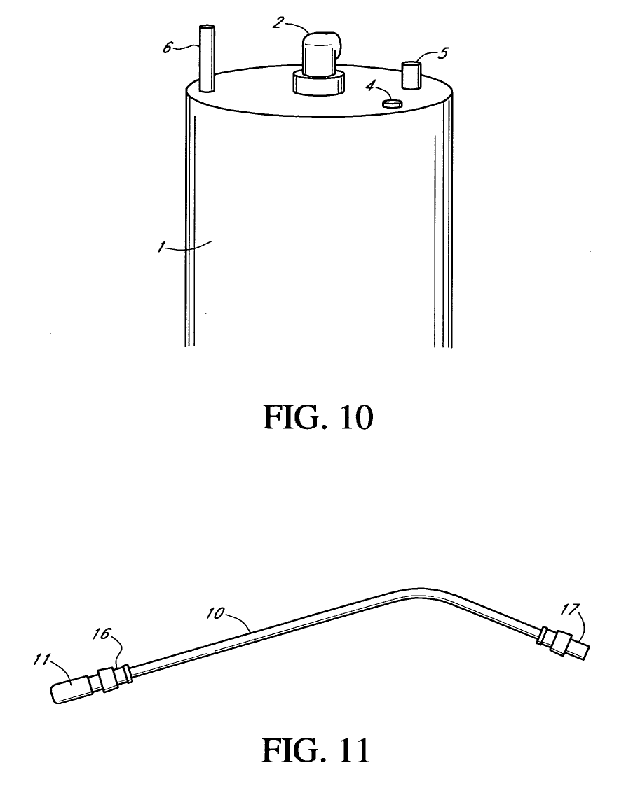

The inventor discloses and claims a method and apparatus for recovering liquid oil, particularly used fryer oil which is typically composed of soy oil, corn oil, peanut oil, Canola oil, olive oil or some combination therein. Referring now to the drawings, wherein like reference numerals designate identical or corresponding parts throughout the several views, FIG. 1 provides a schematic view of one embodiment of the storage tank 1 and vacuum pump 2 portion of the liquid vacuum apparatus. The vacuum pump 2 may be directly mounted on the storage tank 1, as in the embodiment shown in FIGS. 8-10, or the vacuum pump 2 may be fluidly connected to the storage tank 1 via fluid conduit, such as piping 13. In any case, the vacuum pump 2 is configured so that when it is engaged, the inlet of the vacuum pump 2 evacuates contents from the headspace of the storage tank 1 so that the pressure within the storage tank 1 is less than atmospheric pressure (i.e., generally at least less than one atmosphere, depending on the elevation above sea level). In the embodiments shown herein, the contents of the headspace of the storage tank 1 are generally gas and/or vapors. The pump outlet 8 may be fluidly connected to exhaust to any number of different locations or different devices. For example, it may be connected to a filter to remove undesirable components or scents, fluidly connected to vent to an area located a predetermined distance from the storage tank 1 (including somewhere outdoors if the storage tank 1 is located indoors), or simply left to exhaust next to the vacuum pump 2. The vacuum pump 2 as shown is one means of evacuating the vapor from the storage tank 1, as recited in the claims. The storage tank 1 shown in FIGS. 8-10 is insulated so that used oil 15 may be stored in the storage tank 1 for a longer period of time without the oil losing an extensive amount of thermal energy, which increases the viscosity of the used oil 15 and makes it more difficult to transfer. The storage tank 1 is also constructed to such specifications as the particular application dictates. For example, the storage tank 1 will be built to withstand at least the level of vacuum the vacuum pump 2 is capable of generating. The storage tank 1 as shown is one means of storing the liquid to be recovered, as recited in the claims.

In an embodiment not shown herein, valves may be placed on the pump inlet 7, pump outlet 8, vent 4, load-out nozzle 5, tank inlet 6, and other places within the system as the specific application and necessity or convenience dictate. Accordingly, the scope of the present invention is not limited by the specific piping 13 or other fluid conduit used or the valves associated therewith, and variations and modifications from the embodiments disclosed and described herein will occur without departure from the spirit and scope of the present invention.

The used oil 14 is brought into the storage tank 1 via the hose 9, wand 10, end piece 11, and in many embodiments a certain amount of piping 13. The hose 9, wand 10, end piece 11, and piping 13 (if present for that embodiment) are all in fluid communication with one another. That is, during operation, fluid may flow through the end piece 11, into the wand 10, and from the wand 10 through the hose 9 and any associated piping 13 to the storage tank 1. The end piece 11 is secured to the wand first end 16 and the hose 9 is secured to the wand second end 17. The hose 9, wand 10, end piece 11, and piping 13 may be constructed of any materials suitable for the application to which the liquid vacuum apparatus is put. For example, if the apparatus is to be used in handling hot (preferably ranging in temperature from 300 to 500 degrees Fahrenheit) used oil 15 from a food fryer 14, the wand 10, end piece 11, and piping 13 may be constructed of stainless steel, carbon steel, high-grade rubber, Teflon or other polymer insoluble to the used oil 15 and capable of withstanding high temperatures (up to 550 degrees Fahrenheit), or any other material suitable for the specific application that is known to those skilled in the art. The hose 9 may be constructed of materials similar to those indicated for the elements above, but in most applications it will be desirable for the hose 9 to be flexible. Therefore, if a metallic substance is used to construct the hose 9, it will likely be a braided-style hose 9. The material for the hose 9 should be chosen so that the hose 9 possesses similar chemical, heat, and corrosion resistance as other elements in the system.

If piping 13 is included in the system, the hose 9 may be connected to the piping 13 through a connector 12. The connector 12 may be any connector 12 known to those skilled in the art capable of operation under the conditions for any specific application, including but not limited to threaded pipe fittings, cam-lock fittings, and the like. In most embodiments, the materials used to construct the connector 12 should have similar material characteristics (i.e., temperature tolerance, corrosion resistance, etc.) to those used for the hose 9, wand 10, end piece 11, and piping 13. The hose 9 as shown is one means of fluidly communicating the liquid to be recovered to the storage tank 1 or storage means, as recited in the claims.

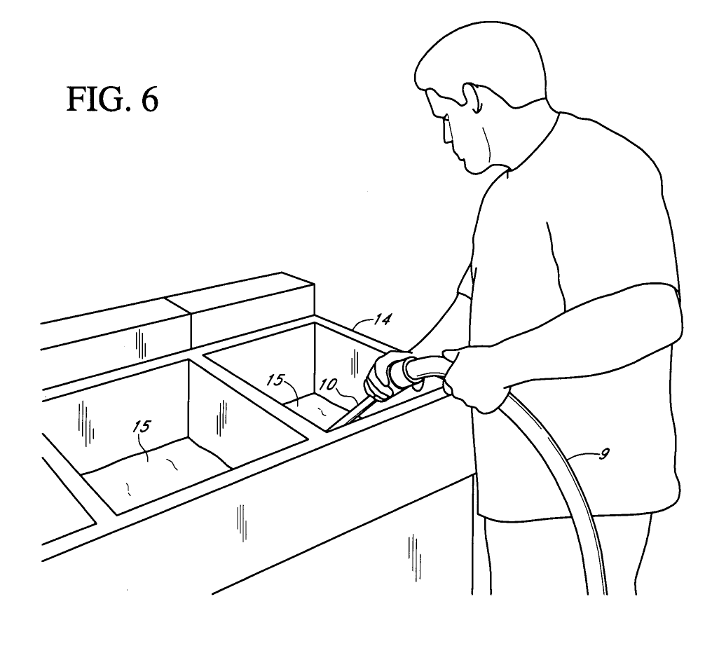

In the embodiments shown in FIGS. 6, 7, 11 the end piece 11 is fashioned as a perforated cap that is affixed to the wand first end 16. In this embodiment, the end piece 11 serves as a rough filter for the used oil 15 and prevents solids that are larger than the perforations within the surface of the end piece 11 from entering the wand 10 and subsequently moving through the other elements of the system. Depending on the application, the end piece 11 may not be needed for a particular embodiment, and therefore, the presence or absence of the end piece in no way limits the scope of the present invention.

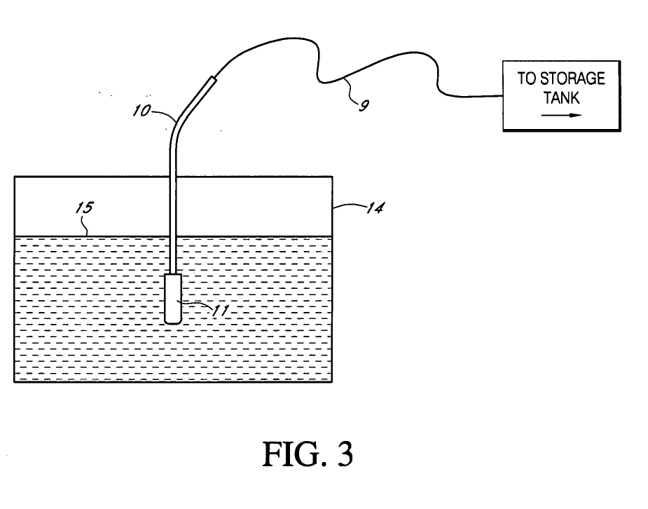

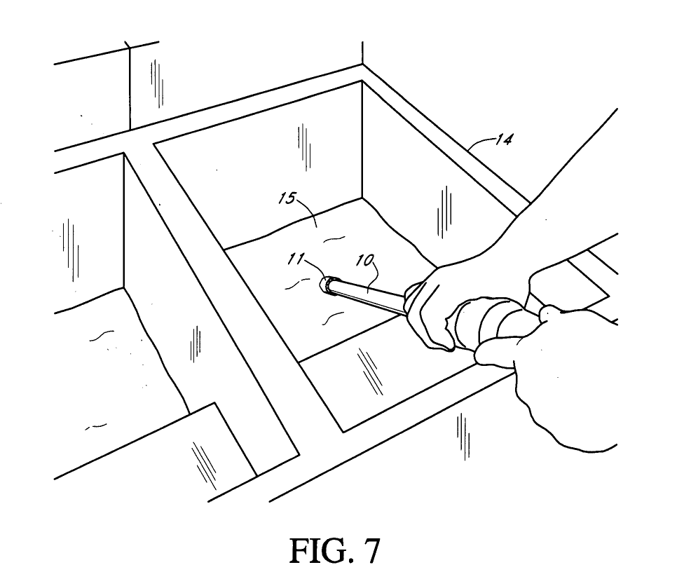

Once the vacuum pump 2 is started, the user grasps the wand 10 (which may be insulated if the user desires to evacuate used oil 15 when it is at an elevated temperature), which is best shown in FIGS. 6 and 7, and inserts the end piece 11 into the used oil 15, which is shown schematically in FIG. 3. The pressure gradient between the used oil 15 and the interior of the storage tank 1 caused by the vacuum pump 2 draws used oil 15 from the food fryer 14 through the end piece 11, wand 10, hose 9, and connector 12 and piping 13 (if used in that particular embodiment) into the storage tank 1. Because the highest pressure value on the pressure gradient created by the vacuum pump 2 is at the used oil 15 level in the food fryer 14, and the pressure at that location is approximately equal to atmospheric pressure, leaks within the system will not cause used oil 15 to spill when the vacuum pump 2 is engaged. That is, a leak in the wand 10, hose 9, connector 12 or piping 13 (if used) will not cause used oil 15 to leak externally as it would if positive pressure was used to produce the motive force for the liquid. Instead, if a leak develops in any component of the system, when the vacuum pump 2 is engaged, air will be drawn through the leaking component rather than used oil 15 leaking externally from the system. The wand 10 and end piece 11 form one combination of intake means as recited in the claims.

Another advantage to using a pressure gradient on which the highest value is atmospheric pressure is that the hose 9, wand 10, end piece 11, and piping 13 may be evacuated of nearly all residual liquid by allowing the vacuum pump 2 to pull air through those elements. Therefore, if a connector 12 and piping 13 are used, when the user disconnects the hose 9 from the piping 13 at the connector 12, the user is assured that only a negligible amount of liquid will be present in the system. The user may allow the vacuum pump 2 to pull enough air through the system so that when the hose 9 is disconnected from the piping 13 at the connector 12, no liquid drips from the hose 9 or the piping 13.

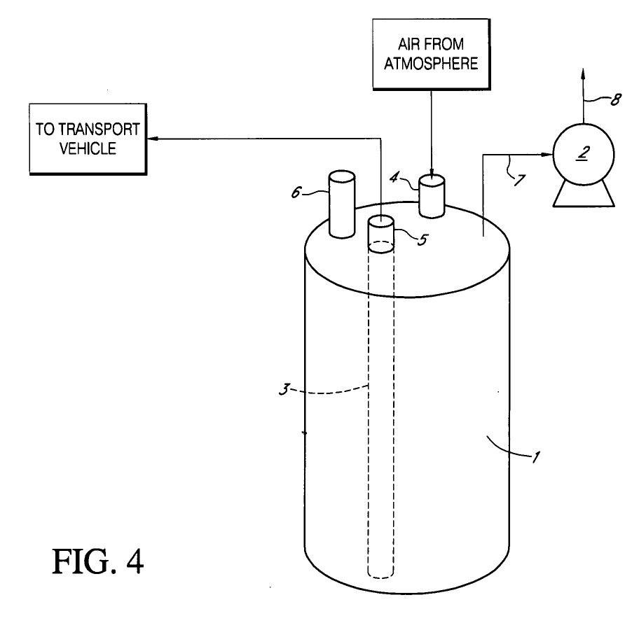

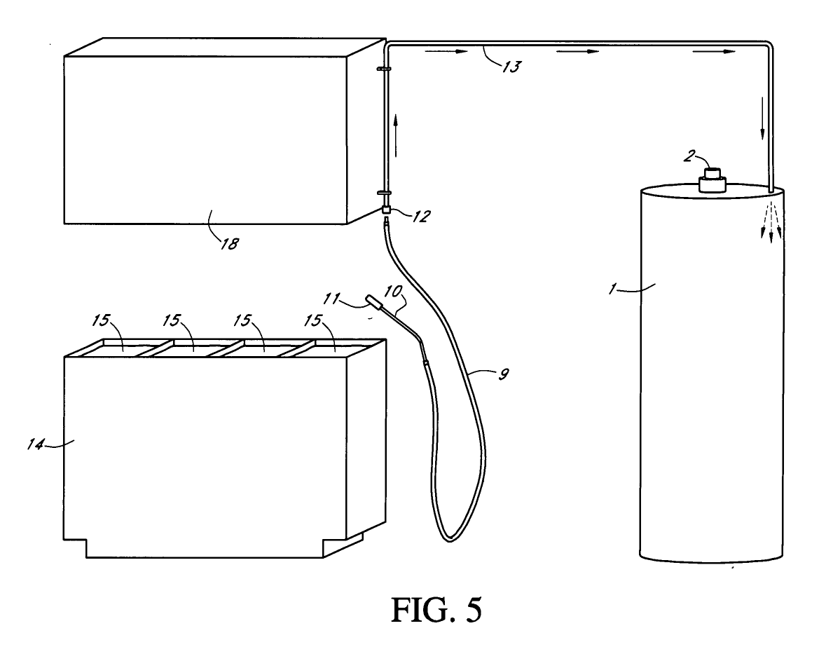

When the storage tank 1 becomes full of liquid, it may easily be emptied. The storage tank 1 is fashioned with a dip tube 3 at the top and of the storage tank 1 extending to between 0.125 and 18 inches from the bottom of the storage tank 1. A load-out nozzle 5 is connected to the top-most portion of the dip tube 3 and provides an interface for evacuating the contents of the storage tank 1. The storage tank 1 is also fashioned with a vent 4 to the atmosphere on the top end of the storage tank 1. In the embodiment shown in FIG. 4, when the storage tank 1 needs to be emptied, the vent 4 on the storage tank 1 is opened and a transport vehicle with a tank and a means for creating a reduced-pressure atmosphere within the tank is fluidly connected to the load-out nozzle 5. The reduced pressure within the tank of the transport vehicle draws the used oil 15 from the storage tank 1 through the dip tube 3 and into the tank on the transport vehicle. As used oil 15 is evacuated from the storage tank 1 into the tank of the transport vehicle, air from the ambient atmosphere around the storage tank 1 migrates into the storage tank 1 through the vent 4. That is, during emptying of the storage tank 1, ambient air is transferred into the storage tank 1 through the vent 4 at the same volumetric flow rate that liquid in the storage tank 1 moves out of the storage tank 1. Therefore, during emptying of the storage tank 1, the atmosphere within the storage tank 1 remains at ambient pressure. This is one method of emptying liquid from the storage tank 1, and modifications and variations to this method will become apparent to those skilled in the art without departing from the spirit and scope of the present invention. For example, the storage tank 1 could be placed in an elevated position relative to a transport vehicle so that gravity would be the motive force causing the liquid in the storage tank 1 to migrate into the tank of the transport vehicle.

It should be noted that the present invention is not limited to the specific embodiments pictured and described herein, but is intended to apply to all similar apparatuses for evacuating liquids from a liquid container using reduced pressure. Modifications and alterations from the described embodiments will occur to those skilled in the art without departure from the spirit and scope of the present invention.

1. A liquid vacuum apparatus comprising:
a. a storage tank 1;
b. a vacuum pump 2 fluidly connected to said storage tank 1 wherein said vacuum pump 2 reduces the pressure within said storage tank 1;
c. a flexible hose 9 fluidly connected to said storage tank 1;
d. a wand 10 fluidly connected to said flexible hose 9; and,
e. an end piece 11 fluidly connected to said wand 10.

2. The liquid vacuum apparatus according to claim 1 wherein said storage tank 1 is insulated.

3. The liquid vacuum apparatus according to claim 2 wherein said wand 10 is insulated.

4. The liquid vacuum apparatus according to claim 1 wherein a filter is positioned between said end piece 11 and said storage tank 1.

5. The liquid vacuum apparatus according to claim 1 wherein a portion of flexible piping having a first and second end is attached to said storage tank 1 at said first end and said wand 10 is attached at said second end of said portion of said flexible piping.

6. A method of removing oil from a container comprising:
a. Generating a reduced pressure within a liquid vacuum apparatus, said liquid vacuum apparatus further comprising:
i. a storage tank 1;
ii. a vacuum pump 2 fluidly connected to said storage tank 1 wherein said vacuum pump 2 reduces the pressure within said storage tank 1;
iii. a flexible hose 9 fluidly connected to said storage tank 1;
iv. a wand 10 fluidly connected to said flexible hose 9; and,
v. an end piece 11 fluidly connected to said wand 10;
b. Positioning said end piece 11 in the oil to be evacuated from the liquid container wherein said oil is at atmospheric pressure; and,
c. Allowing the reduced pressure within said storage tank 1 to urge the oil from said liquid container into said storage tank 1.

7. The method of removing oil from a container according to claim 6 wherein said end piece 11 is removed from the oil in the liquid container and air is allowed to pass through said liquid vacuum apparatus for a period of time to ensure that all liquid is removed from said wand 10, hose 9, and piping 13.

8. The method of removing oil from a container according to claim 7 wherein said hose 9 may be disconnected from said piping 13 at said connector 12 without any spillage of liquid.

9. The method of removing oil from a container according to claim 6 wherein the oil is used food fryer oil 15 and said liquid container is a food fryer 14.

10. The method of removing oil from a container according to claim 9 wherein the oil is liquid having a temperature over 300 degrees Fahrenheit.

11. The method of removing oil from a container according to claim 6 wherein said storage tank 1 is insulated.

12. The method of removing oil from a container according to claim 6 wherein a filter is positioned between said end piece 11 and said storage tank 1.

13. The method of removing oil from a container according to claim 6 wherein a portion of flexible piping having a first and second end is attached to said storage tank 1 at said first end and said wand 10 is attached at said second end of said portion of said flexible piping.

14. A liquid vacuum apparatus comprising:
a. a storage means;
b. a vacuum means fluidly connected to said storage means wherein said vacuum means reduces the pressure within said storage means;
c. a conduit means in fluid communication with said storage means; and,
d. an intake means in fluid communication with said conduit means, said intake means allowing intake of a liquid for containment and control of said liquid in said storage means wherein said liquid is at atmospheric pressure.

15. The liquid vacuum apparatus according to claim 14 wherein said liquid is used fryer oil 15.

16. The liquid vacuum apparatus according to claim 15 wherein said used fryer oil has a temperate above 300 degrees Fahrenheit and said storage means and said intake means are insulated to allow evacuation and maintain said used fryer oil 15 in a liquid state.

17. The liquid vacuum apparatus according to claim 15 wherein said used fryer oil has a temperate between 300 degrees Fahrenheit and 550 degrees Fahrenheit and said storage means and said intake means are insulated to allow evacuation and maintain said used fryer oil 15 in a liquid state.

18. The liquid vacuum apparatus according to claim 15 wherein a filtering means may be positioned at said intake means for particulate removal prior to storage of said liquid.

19. The liquid vacuum apparatus according to claim 16 wherein a filtering means may be positioned at said intake means for particulate removal prior to storage of said liquid.

20. The liquid vacuum apparatus according to claim 17 wherein a filtering means may be positioned at said intake means for particulate removal prior to storage of said liquid.
